(19) United States
(12) Patent Application Publication
(10) Pub. No.: US 2019/0076875 A1
(43) Pub. Date: Mar. 14, 2019

(54) METAL SUBSTRATE AND METHOD OF MAKING AND USING THE SAME

(71) Applicant: GM Global Technology Operations LLC, Detroit, MI (US)

(72) Inventor: Frank D. Risko, Clarkston, MI (US)

(21) Appl. No.: 15/699,213

(22) Filed: Sep. 8, 2017

(51) Int. Cl. B05D 3/00; B05D 7/14; B23K 26/362

(52) U.S. Cl. CPC B05D 3/002; B05D 7/14; B23K 26/362; B60B 2310/654; B60B 2900/141; B60B 2360/104; B60B 2360/30; B60B 2310/202; B60B 2310/208; B60B 2310/616

(57) ABSTRACT

A number of variations may include a product including a substrate comprising a metal comprising an etched region and a first layer comprising a clear coat overlying the etched region wherein the etched region is constructed and arranged to improve filiform corrosion resistance on the substrate.

### TECHNICAL FIELD

The field to which the disclosure generally relates to includes metal substrates.

### BACKGROUND

In a number of variations, metal substrates may be used for surfaces of a number of products including, but not limited to, vehicle components.

### SUMMARY OF ILLUSTRATIVE VARIATIONS

A number of variations may include a product which may include: a substrate comprising a metal comprising an etched region and a first layer comprising a clear coat overlying the etched region wherein the etched region is constructed and arranged to improve filiform corrosion resistance on the substrate.

A number of variations may include a method which may include: providing a substrate comprising a metal; etching the metal to form an etched region; and overlying the etched region with a first layer comprising a clear coat wherein the etched region is constructed and arranged to improve filiform corrosion resistance on the substrate.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1A is a schematic illustration of a product according to a number of variations.

FIG. 1B is a schematic illustration of a product according to a number of variations.

FIG. 2A is a graphic illustration of a product according to a number of variations.

FIG. 2B is a graphic illustration of a product according to a number of variations.

### DETAILED DESCRIPTION OF ILLUSTRATIVE VARIATIONS

The following description of the variations is merely illustrative in nature and is in no way intended to limit the scope of the invention, its application, or uses.

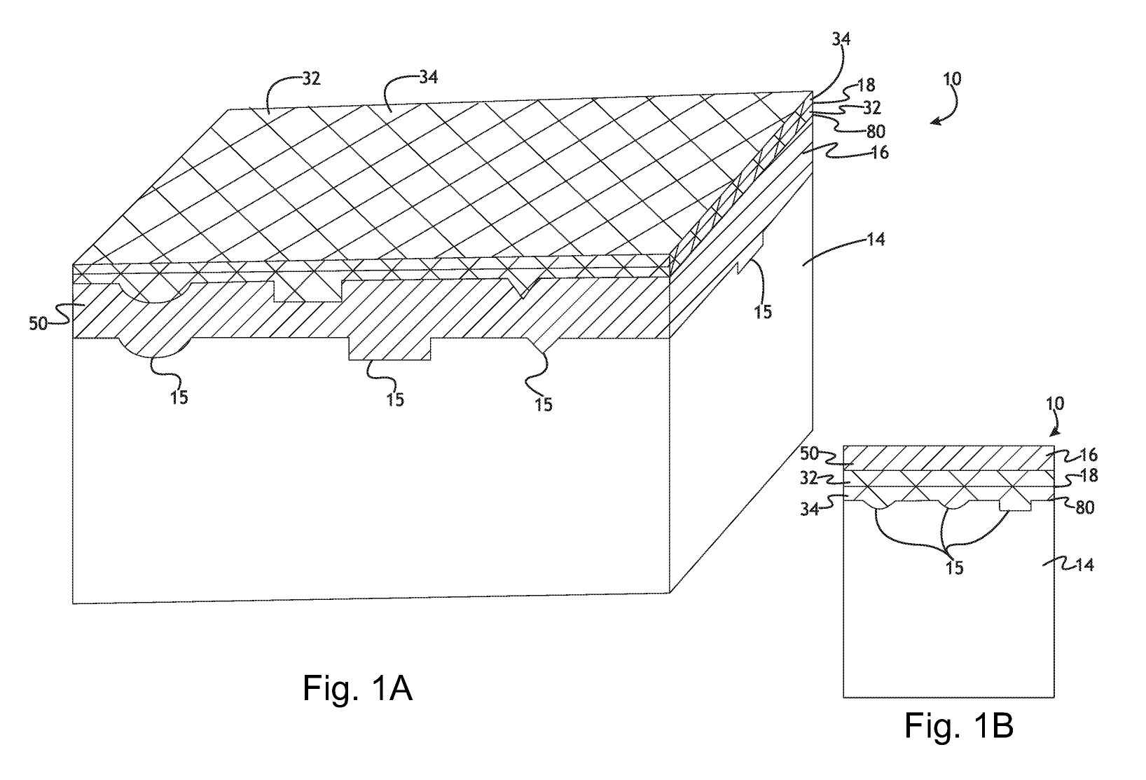

FIGS. 1A and 1B illustrate a product 10 according to a number of variations. In a number of variations, the product 10 may include a substrate 14. In a number of variations, the substrate 14 may include a metal. In a number of variations, the substrate 14 may include an etched region 15. In a number of variations, the substrate 14 may include a first layer 16 overlying at least a portion of the substrate 14. In a number of variations, the first layer 16 may overlie the etched region 15. In a number of variations, the first layer 16 may include a clear coat 50. In a number of variations, the first layer 16 may include at least one of a primer 32 or a hard coat 34. In a number of variations, the substrate 14 may include a second layer 18 overlying the first layer 16. In a number of variations, the second layer 18 may include a clear coat 50. In a number of variations, the second layer 18 may include at least one of a primer 32 or a hard coat 34. In a number of variations, the second layer 18 may overlie the substrate 14 and underlie the first layer 16. In a number of variations, the substrate 14 may include a plurality of layers of the first layer 16 and/or second layer 18 in any orientation overlying or underlying each other. In a number of variations, the second layer 18 may lie between the first layer 16 and the substrate 14. In a number of variations, additional layers may lie on the substrate 14 and oriented overlying or underlying the first layer 16 and/or the second layer 18. In a number of variations, the etched region 15 may be constructed and arranged to improve filiform corrosion resistance on the substrate 14. In a number of variations, the substrate 14 may be an exterior panel or an interior panel for a vehicle. In a number of variations, the substrate 14 may be used as, but is not limited to, an underwater panel, a pigment stability panel, an emblem panel, a spoiler, a car door, a car hood, a side panel, a bumper, a rear panel, a headlight, or may be used in another way. In a number of variations, the substrate 14 may include a roadwheel for a vehicle. In a number of variations, the vehicle may include a motor vehicle, watercraft, spacecraft, aircraft, or may be another type.

In a number of variations, the substrate 14 may comprise a material including, but not limited to, plastic steel, stainless steel, copper, nickel, tin, noble metals, zinc, iron, bronze, aluminum, silicon, titanium, platinum, shellac, amber, aramid (including Twaron, Kevlar, Technora, Nomax), silk, leather, rubber, natural rubber, synthetic rubber, silicone rubber, fluoroelastomer rubber, butyl rubber (isobutylene-isoprene), hypalon rubber (chlorosulphonated polyethylene), epichlorohydrin rubber (epichlorohydrin), ethylene propylene diene rubber, fluorocarbon rubber, fluorosilicone rubber, hydrogenated nitrile rubber, nitrile rubber, perfluoroelastomer rubber, polyacrylic rubber, chloroprene rubber, polyurethane rubber, styrene butadiene rubber, acrylonitrile-butadiene rubber, hydrogenated acrylonitrile-butadiene rubber, ethylene acrylic rubber, phenol formaldehyde, polyether urethane, polyester urethane, neoprene, nylon, polyvinyl chloride, polystyrene, polyethylene, polypropylene, polyurethane, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys thereof, combinations thereof, or may be another type. In a number of variations, the substrate 14 may be formed through metal forming, forging, molding, flow forming, rolling, extrusion, laser cladding, metalworking, sintering, fabrication, welding, molding, brazing, casting, extrusion, forging, heat treatment, hydroforming, punching, shearing, spinning, or may be formed another way. In a number of variations, the substrate 14 may be manufactured or woven through weaving, knitting, braiding, stitching, plain weaving, satin weaving, or may be manufactured in another way. In a number of variations, the substrate 14 may have various widths, lengths and/or diameters of fibers as well as in its overall dimensions. In a number of variations, the substrate 14 may be preimpregnated, coated, or otherwise in contact with a bonding agent 80. In a number of variations, the substrate 14 may include an aluminum or aluminum alloy. In a number of variations, the substrate 14 may include a wrought aluminum alloy including, but not limited to, 1050, 1060, 1100, 1199, 2014, 2024, 2219, 3003, 3004, 3102, 4041, 5005, 5052, 5083, 5086, 5154, 5356, 5454, 5456, 5754, 6005, 6005A, 6060, 6061, 6063, 6066, 6070, 6082, 6105, 6162, 6262, 6351, 6463, 7005, 7022, 7067, 7072, 7075, 7079, 7116, 7129, 7178, or may be another type. In a number of variations, the substrate 14 may include a cast aluminum alloy including, but not limited to, ANSI numbers: 201.0, 204.0, 242.0, A242,0 295.0, 319.0, 328.0, 355.0 C355.0, 356.0, A356.0, 443.0, B443.0, 512.0, 514.0, 520.0, 535.0, 705.0, 707.0, 710.0, 712.0, 713.0, 771.0, 850.0, 851.0, 852.0, or may be another type. In a number of variations, the substrate may include an aluminum alloy including iron, copper, magnesium, manganese, silicon, zinc, zirconium, nickel, or another metal in any concentration. In a number of variations, the substrate 14 may include A356 T6 cast aluminum. In a number of variations, the substrate 14 may include 6061 tempered aluminum alloy. In a number of variations, the substrate 14 may be cast, forged, polished, or may be modified, treated, or formed a different way. In a number of variations, various types of substrates may be laser etched.

In a number of variations, the first layer 16 or second layer 18 may include a primer 30. In a number of variations, the primer 30 may include diacetone alcohol in a weight percentage of approximately 10%≥x≥30%. In a number of variations, the primer 30 may include 1-methoxy-2-propanol in a weight percentage of approximately 60%≥x≥90%; in a number of variations, the weight percentage may be approximately 65%≥x≥85%; in a number of variations, the weight percentage may be approximately 70%≥x≥80%; in a number of variations, the weight percentage may be approximately 72%≥x≥78%; or any range therebetween. In a number of variations, the primer 30 may include dibenzoylresorcine in a weight percentage of approximately 1%≥x≥5%; in a number of variations, the weight percentage may be approximately 1.5%≥x≥4.5%; in a number of variations, the weight percentage may be approximately 2%≥x≥4%; in a number of variations, the weight percentage may be approximately 2.5%≥x≥3.5%; or any range therebetween. In a number of variations, the primer 30 may include polymethyl methacrylate in a weight percentage of approximately 5%≥x≥10%; in a number of variations, the weight percentage may be approximately 5.5%≥x≥9.5%; in a number of variations, the weight percentage may be approximately 6%≥x≥9%; in a number of variations, the weight percentage may be approximately 7%≥x≥8%; or any range therebetween. In a number of variations, a plurality of layers of the primer 30 may be used in the first layer 16 or second layer 18. In a number of variations, the primer 30 may be applied to or deposited on the substrate 14 or first 16 or second layer 18 or additional layers through dip coating, spray coating, flow coating, painting, or may be applied or deposited a different way. In a number of variations, the thickness of the primer 30 may be about 1.0 μmx≥10.0 μm.

In a number of variations, the first layer 16 or second layer 18 may include a hard coat 32. In a number of variations, the hard coat 32 may include methanol in a weight percentage of approximately 10%≥x≥30%; in a number of variations, the weight percentage may be approximately 12%≥x ≥27%; in a number of variations, the weight percentage may be approximately 15%≥x≥25%; in a number of variations, the weight percentage may be approximately 17%≥x≥23%; or any range therebetween. In a number of variations, the hard coat 32 may include n-butanol in a weight percentage of approximately 10%≥x≥30%; in a number of variations, the weight percentage may be approximately 12%≥x≥27%; in a number of variations, the weight percentage may be approximately 15%≥x ≥25%; in a number of variations, the weight percentage may be approximately 17%≥x≥23%; or any range therebetween. In a number of variations, at least one of the hard coat 32 may include 2-propanol in a weight percentage of approximately 10%≥x≥30%; in a number of variations, the weight percentage may be approximately 12%≥x≥27%; in a number of variations, the weight percentage may be approximately 15%≥x≥25%; in a number of variations, the weight percentage may be approximately 17%≥x≥23%; or any range therebetween. In a number of variations, at least one of the hard coat 32 may include acetic acid in a weight percentage of approximately 1%≥x≥5%; in a number of variations, the weight percentage may be approximately 1.5%≥x≥4.5%; in a number of variations, the weight percentage may be approximately 2%≥x≥4%; in a number of variations, the weight percentage may be approximately 2.5%≥x≥3.5%; or any range therebetween. In a number of variations, the hard coat 32 may include 1-methoxy-2-propanol in a weight percentage of approximately 1%≥x≥5%; in a number of variations, the weight percentage may be approximately 1.5%≥x ≥4.5%; in a number of variations, the weight percentage may be approximately 2%≥x≥4%; in a number of variations, the weight percentage may be approximately 2.5%≥x≥3.5%; or any range therebetween. In a number of variations, the hard coat 32 may include modified silicone resin in a weight percentage of approximately 10%≥x≥30%; in a number of variations, the weight percentage may be approximately 12%≥x≥27%; in a number of variations, the weight percentage may be approximately 15%≥x≥25%; in a number of variations, the weight percentage may be approximately 17%≥x≥23%; or any range therebetween. In a number of variations, the hard coat 32 may include water in a weight percentage of approximately 10%≥x≥30%; in a number of variations, the weight percentage may be approximately 12%≥x ≥27%; in a number of variations, the weight percentage may be approximately 15%≥x≥25%; in a number of variations, the weight percentage may be approximately 17%≥x≥23%; or any range therebetween. In a number of variations, the hard coat 32 may comprise the entirety of the first layer 16 or the second layer 18. In a number of variations, a plurality of layers of the hard coat 32 may be used in the first layer 16 or second layer 18. In a number of variations, the first layer 16 or second layer 18 may include a plurality of layers of the hard coat 32 and primer 30 in any orientation overlying or underlying each other. In a number of variations, the hard coat 32 may be applied to or deposited on the substrate 14 or first 16 or second layer 18 or additional layers through dip coating, spray coating, flow coating, painting, or may be applied or deposited a different way. In a number of variations, the thickness of the hard coat 32 may be about 1.0 μm≥x≥10.0 μm.

In a number of variations, the first layer 16 or second layer 18 may include a clear coat 50. In a number of variations, the clear coat 50 may include heptan-2-one in a weight percentage of approximately 10%≥x≥25%; in a number of variations, the weight percentage may be approximately 12%≥x≥22%; in a number of variations, the weight percentage may be approximately 15%≥x≥20%; in a number of variations, the weight percentage may be approximately 17%≥x≥19%; or any range therebetween. In a number of variations, the clear coat 50 may include acetic acid hexyl ester in a weight percentage of approximately 10%≥x≥25%; in a number of variations, the weight percentage may be approximately 12%≥x≥22%; in a number of variations, the weight percentage may be approximately 15%≥x≥20%; in a number of variations, the weight percentage may be approximately 17%≥x≥19%; or any range therebetween. In a number of variations, the clear coat 50 may include n-butyl acetate in a weight percentage of approximately 5%≥x≥10%; in a number of variations, the weight percentage may be approximately 6%≥x≥9%; in a number of variations, the weight percentage may be approximately 7%≥x≥8%; in a number of variations, the weight percentage may be approximately 7.2%≥x≥7.8%; or any range therebetween. In a number of variations, the clear coat 50 may include 2-butoxyethyl acetate in a weight percentage of approximately 1%≥x≥5%; in a number of variations, the weight percentage may be approximately 1.5%≥x≥4.5%; in a number of variations, the weight percentage may be approximately 2%≥x≥4%; in a number of variations, the weight percentage may be approximately 2.5%≥x≥3.5%; or any range therebetween. In a number of variations, the clear coat 50 may include Poly(oxy-1,2-ethanediyl), alpha.-[3-[3-(2H-benzotriazol-2-yl)-5- (1,1dimethylethyl)-4-hydroxyphenyl]-1-oxopropyl]-.omega.-hydroxy- in a weight percentage of approximately 1%≥x≥5%; in a number of variations, the weight percentage may be approximately 1.5%≥x≥4.5%; in a number of variations, the weight percentage may be approximately 2%≥x≥4%; in a number of variations, the weight percentage may be approximately 2.5%≥x≥3.5%; or any range therebetween. In a number of variations, the clear coat 50 may comprise the entirety of the second layer 18. In a number of variations, the clear coat 50 may comprise the entirety of the first layer 16. In a number of variations, the clear coat 50 may be applied to or deposited on the substrate 14 or first 16 or second layer 18 or additional layers through dip coating, spray coating, flow coating, painting, or may be applied or deposited a different way. In a number of variations, the thickness of the clear coat 50 may be about 25 μm≥x≥75 μm.

Still referring to FIGS. 1A and 1B, in a number of variations a bonding agent 80 may be held in contact with the substrate 14, first layer 16, or second layer 18, or additional layers. In a number of variations, this contact may result in adherence or bonding between the bonding agent 80, the substrate 14, first layer 16, or second layer 18, or any combination thereof. In a number of variations, the bonding agent 80 may include urethane resin, vinylester resin, polyester resin, epoxy resin, phenolic resin, modified phenolic resin or may be another type. In a number of variations, the bonding agent 80 may be reactive or non-reactive. In a number of variations, the bonding agent 80 may be applied to or deposited on the substrate 14, first layer 16 or second layer 18 or another layer of the substrate 14 through dip coating, spray coating, flow coating, painting, or may be applied or deposited a different way.

In a number of variations, the product 10 may have the etched region 15 formed through a process involving a laser. In a number of variations, the product 10 may have the etched region 15 formed through a process involving laser etching. In a number of variations, an assist gas directed to the metal substrate 15 may be used and may be any suitable gas which may be used to facilitate the controlled formation of an oxide film. In a number of variations, the assist gas may be selected from the group consisting of argon, air, helium, oxygen and nitrogen. In a number of variations, the gas may be applied to the metal surface by any suitable means, as will be described hereafter in more detail, but may be directed to the surface in a continuous manner, for example, via a nozzle or as a laminar flow across the surface of the metal substrate 15 to which the beam is being applied. In a number of variations, the gas pressure and flow rate of the assist gas may be selected to ensure that the film formation on the metal substrate 14 is facilitated. In a number of variations, the assist gas may be supplied to the metal surface at a pressure of from 0.5 to 3 bar and at a flow rate of from 50 to 100 l/min.

In a number of variations, the laser applied to the metal substrate 14 may include any conventional laser, provided that film formation on the metal substrate 14 is facilitated by the action of the laser under the influence of the assist gas. In a number of variations, the laser may be a UV or visible laser. In a number of variations, the laser may be selected from the group consisting of a KrF excimer laser of wavelength 248 nm, a 4th harmonic YAG laser of wavelength 266 nm, an XeCl excimer laser of wavelength 308 nm, an XeF excimer laser of wavelength 351 nm, a 3rd harmonic Nd:YAG laser of wavelength 355 nm, a 2nd harmonic Nd: YAG laser of wavelength 532 nm and argon-ion lasers with their harmonic wavelengths. In a number of variations, the laser may include, include neodymium:yttrium aluminum garnet (Nd:YAG) lasers, carbon dioxide (CO₂) lasers, diode lasers, excimer lasers, or may be another type. In a number of variations, YAG lasers emit light in the near-infrared spectrum at wavelengths of 1064 nm. Such lasers may have continuous power outputs of from about 1 to about 50 watts, and can be operated in a pulsed mode at typical peak powers of from about 1 watt to about 45 kilowatts. In a number of variations, CO₂ lasers emit light in the far-infrared region of the spectrum, with intensity spikes at wavelengths of 9.8 and 10.6 microns. Such CO₂ lasers may operate at a continuous output power of from about 1 to about 40 watts. For pulsed mode operation, frequencies of from about 1 to about 64,000 pulses/second may be used. In a number of variations, the laser may be applied to the surface of the metal in either continuous wave or pulse mode. In a number of variations, the laser beam profile of the laser beam may be a top hat flat beam. Other beam modes, such as TEM 00 and TEM 01 may also be used. In a number of variations, Gaussian beams may also be used. If applied in pulse mode, the laser pulse duration may affect the oxidation process at the metal surface given that it determines the peak power of the laser beam. In a number of variations, the pulse duration may be from about 1-100 ns, or may be about 1-30 ns.

In a number of variations, the laser beam, the movement of which can be controlled by a computer, may be used to create discrete symbols or designs on the substrate 14 or, alternatively, may be serially indexed across the surface of the marking material to create multiple symbols or designs at the same time. In a number of variations, a word may be created by separately making each letter of the word with the laser, or by rastering the laser across the entire word to form all of the letters at the same time. In a number of variations, the substrate 14 may be in motion in accordance with the laser to etch the substrate 14 at various points. In a number of variations, the substrate 14 may be spun to ensure a more complete etched region 15 depending on the application of the substrate 14. During laser exposure, the surface of the substrate may be exposed to any desired type of atmosphere. In a number of variations, the atmosphere may comprise air at atmospheric, sub-atmospheric or super-atmospheric pressures. Furthermore, the atmosphere may comprise an inert gas such as nitrogen, argon or carbon dioxide, an oxidizing atmosphere such as air or oxygen, a reducing atmosphere such as hydrogen or carbon monoxide, or a vacuum.

In a number of variations, oxidizing or reducing gases may be used in a combination with inert gases. In a number of variations the atmosphere to which the surface of the substrate 14 may be exposed may affect the color and the quality of the mark. In a number of variations, a single laser beam may be used for etching. In a number of variations, two or more laser beams may be used. For example, a first laser beam may be used to preheat the marking material and substrate, followed by a second laser which may be used to adhere the marking material to the preheated substrate. In a number of variations, various types of substrates 14 may be laser etched.

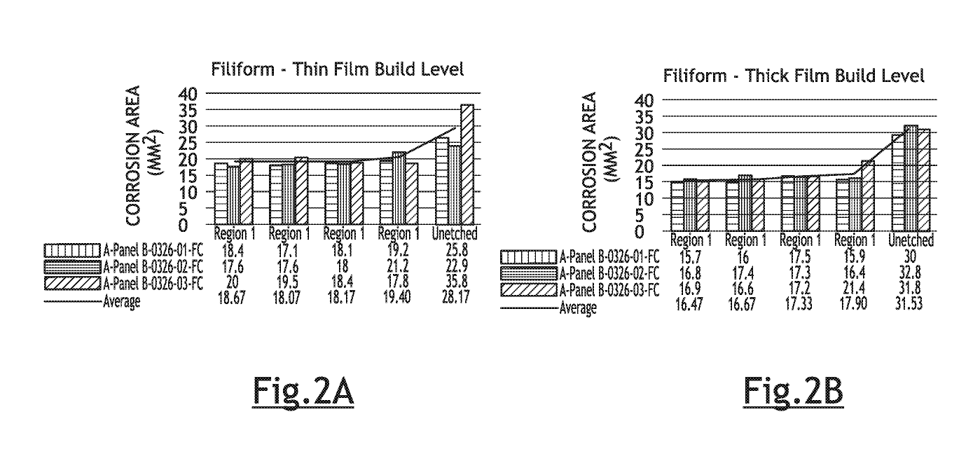

FIGS. 2A-2B show the product 10 according to a number of variations. In a number of variations, as shown in FIGS. 2A-2B, the product 10 may undergo filiform corrosion. In a number of variations, as shown in FIGS. 2A-2B, a SAE filiform test (J2635—Filiform Corrosion) was done on different etched regions 15 of different metal substrates 14 where area of filiform corrosion within a 25.4 mm length of etched region 15 were recorded and measured. Region 1 had an etched region formed with laser etching settlings at 80% 70K; 0.03, 500 mps. Region 2 had an etched region formed with laser etching settlings at 70% 60K; 0.05, 500 mps. Region 3 had an etched region formed with laser etching settlings at 70% 50K; 0.03, 500 mps. Region 4 had an etched region formed with laser etching settlings at 60% 50K; 0.05, 500 mps. In a number of variations, based on thin (about 40 μm dry film thickness, shown in FIG. 2A) or thick (about 80 μm dry film thickness, shown in FIG. 2B) film build level coverage of the substrate by the clearcoat 50, the etched regions 15 achieved lower filiform build level than the unetched portions. In a number of variations, laser etching of the substrate 14 may improve filiform corrosion resistance or retard filiform corrosion under clear coat 50 as the filiform area was significantly less for etched regions 15 versus unetched regions of substrates 15, as shown in FIGS. 2A-2B. In a number of variations, this may improve the durability, performance of a substrate 14. In a number of variations, the etched regions 15 of a substrate 14 may replace use of a conversion coating (which may contain zirconium or titanium), may reduce the thickness of the clear coat 50, or may reduce the thickness of the bonding agent 80.

In a number of variations, a method 800 may be shown. In a number of variations, the method 800 may include in block 802 providing a substrate 14 comprising a metal. In a number of variations, the method 800 may further include, in block 804, etching the metal to form an etched region 15. In a number of variations, the method 800 may further include, in block 806, overlying the etched region 15 with a first layer 16 comprising a clear coat 50 wherein the etched region 15 is constructed and arranged to improve filiform corrosion resistance on the substrate 14. In a number of variations, the method 800 may further include, in block 808, depositing a second layer 18 comprising at least one of a hardcoat 34 or a primer 32 between the first layer 16 and the substrate 14. In a number of variations, the method 800 may further include, in block 810, depositing a second layer 18 comprising at least one of a hardcoat 34 or a primer 32 between the first layer 16 and the substrate 14. In a number of variations, the method 800 may further include, in block 812, depositing additional layers on the substrate 14.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may involve a product that may include a substrate comprising a metal comprising an etched region and a first layer comprising a clear coat overlying the etched region wherein the etched region is constructed and arranged to improve filiform corrosion resistance on the substrate.

Variation 2 may include the product according to variation 1 wherein the metal comprises aluminum.

Variation 3 may include the product according to any of variations 1-2 wherein the etched region is formed from laser etching.

Variation 4 may include the product according to any of variations 1-3 wherein the substrate comprises a roadwheel for a vehicle.

Variation 5 may include the product according to any of variations 1-4 wherein the clear coat comprises an acrylic.

Variation 6 may include the product according to any of variations 1-6 wherein the laser etching is done with a carbon dioxide or yttrium based laser.

Variation 7 may include the product according to any of variations 1-6 wherein the substrate further comprises a casted region.

Variation 8 may include the product according to any of variations 1-7 wherein the substrate further comprises a primer region.

Variation 9 may include the product according to any of variations 1-8 wherein the substrate further comprises a polymer resin which binds the clear coat to the etched region.

Variation 10 may include the product according to any of variations 1-9 wherein the substrate is forged.

Variation 11 may include the method that may include providing a substrate comprising a metal; etching the metal to form an etched region; and overlying the etched region with a first layer comprising a clear coat wherein the etched region is constructed and arranged to improve filiform corrosion resistance on the substrate.

Variation 12 may include the method according to variation 11 wherein the metal comprises aluminum.

Variation 13 may include the method according to any of variations 11-12 wherein the etched region is formed from laser etching.

Variation 14 may include the method according to any of variations 11-13 wherein the substrate comprises a roadwheel for a vehicle.

Variation 15 may include the method according to any of variation 11-14 wherein the clear coat comprises an acrylic.

Variation 16 may include the method according to any of variations 11-15 wherein the laser etching is done with a carbon dioxide or yttrium based laser.

Variation 17 may include the method according to any of variations 11-16 wherein the substrate further comprises a casted region.

Variation 18 may include the method according to any of variations 11-17 wherein the substrate further comprises a primer region.

Variation 19 may include the method according to any of variations 11-18 wherein the substrate further comprises a polymer resin which binds the clear coat to the etched region.

Variation 20 may include the method according to any of variations 11-19 wherein the substrate is forged.

The above description of select variations within the scope of the invention is merely illustrative in nature and, thus, variations or variants thereof are not to be regarded as a departure from the spirit and scope of the invention.

1. A product comprising:
a substrate comprising a metal comprising an etched region and a first layer comprising a clear coat overlying the etched region wherein the etched region is constructed and arranged to improve filiform corrosion resistance on the substrate.

2. A product as set forth in claim 1 wherein the metal comprises aluminum.

3. A product as set forth in claim 1 wherein the etched region is formed from laser etching.

4. A product as set forth in claim 1 wherein the substrate comprises a roadwheel for a vehicle.

5. A product as set forth in claim 1 wherein the clear coat comprises an acrylic.

6. A product as set forth in claim 3 wherein the laser etching is done with a carbon dioxide or yttrium based laser.

7. A product as set forth in claim 1 wherein the substrate further comprises a casted region.

8. A product as set forth in claim 1 wherein the substrate further comprises a primer region.

9. A product as set forth in claim 1 wherein the substrate further comprises a polymer resin which binds the clear coat to the etched region.

10. A product as set forth in claim 1 wherein the substrate is forged.

11. A method comprising:
providing a substrate comprising a metal;
etching the metal to form an etched region; and
overlying the etched region with a first layer comprising a clear coat wherein the etched region is constructed and arranged to improve filiform corrosion resistance on the substrate.

12. A method as set forth in claim 11 wherein the metal comprises aluminum.

13. A method as set forth in claim 11 wherein the etched region is formed from laser etching.

14. A method as set forth in claim 11 wherein the substrate comprises a roadwheel for a vehicle.

15. A method as set forth in claim 11 wherein the clear coat comprises an acrylic.

16. A method as set forth in claim 13 wherein the laser etching is done with a carbon dioxide or yttrium based laser.

17. A method as set forth in claim 11 wherein the substrate further comprises a casted region.

18. A method as set forth in claim 11 wherein the substrate further comprises a primer region.

19. A method as set forth in claim 11 wherein the substrate further comprises a polymer resin which binds the clear coat to the etched region.

20. A method as set forth in claim 11 wherein the substrate is forged.
